(19) United States
(12) Patent Application Publication
(10) Pub. No.: US 2009/0120713 A1
(43) Pub. Date: May 14, 2009

(54) Motor-Vehicle/Gearwheel Arrangement for a Motor Vehicle Auxiliary Gearing, and Power Steering System Drive Gearwheel Arrangement

(75) Inventor: Stephan Oberle, Villingen-Schwenningen (DE)

Correspondence Address: THE NATH LAW GROUP, 112 South West Street, Alexandria, VA, 22314, US

(73) Assignee: IMS GEAR GMBH, Eisenbach (DE)

(21) Appl. No.: 12/085,030

(22) PCT Filed: Nov. 15, 2006
(86) PCT No.: PCT/EP2006/010958

§ 371 Date: May 15, 2008

(30) Foreign Application Priority Data
Nov. 16, 2005 (DE) 10 2005 055 051.7

(51) Int. Cl. B62D 5/04; F16H 55/17

(52) U.S. Cl. 180/444; 74/431

(57) ABSTRACT

The invention relates to a motor-vehicle/gearwheel arrangement for a motor-vehicle auxiliary gearing having a gearwheel, having a flange arrangement with at least one, preferably two flanges, wherein the gearwheel is arranged adjacent to at least one of the flanges such that these rotate about a common rotational axis and engage one into the other, and with at least one connecting element for connecting the gearwheel to at least one of the flanges. An arrangement according to a first independent embodiment is advantageous in that the gearwheel has at least one connecting-element receiving depression which leads into the body of the gearwheel parallel to the rotational axis, or has, from the body of the gearwheel, an elevation for receiving the connecting element. An arrangement according to a second independent embodiment is advantageous in that the at least one flange has at least one connecting-element receiving depression which leads into the body of the flange parallel to the rotational axis, or has, rising from the body, an elevation for receiving the connecting element. The two embodiments therefore differ by a mirror-inverted arrangement of the individual components for their connection.

The invention relates to a motor-vehicle/gearwheel arrangement for a motor vehicle auxiliary gearing having the features described in the preamble of claim 1 and to the use of such a gearwheel arrangement in a power steering system drive.

An electrical steering device for motor vehicles having a gearwheel arrangement is known from WO 02/38432 A1. The central element is an actual gearwheel made of injection molded plastic. A pass-through opening acting as a gearwheel-shaft opening surrounds an intrinsically disk-shaped body of the gearwheel around a rotational axis. Furthermore, pass-through openings spaced apart from the gearwheel-shaft opening lead through the body of the gearwheel in a direction parallel to the rotational axis. These pass-through openings serve to allow for the passage of connecting elements to connect the gearwheel to two flanges of a flange arrangement. To this end, the flanges are arranged adjacent to the gearwheel such that they rotate around the common rotational axis and also mutually engage each other.

In addition, elastic connecting elements are placed in the vicinity of the gearwheel-shaft opening between a flange projection, which extends in the axial direction and has a cylindrical outer circumference, and an inside wall of the gearwheel. These elastic connecting elements have elastic projections, which extend in a straight line, in the radially external direction, into the recesses of the bulk of the body of the gearwheel. These elastic projecting elements provide for a damped transmission of forces between the gearwheel and the flanges when there is a change in the acceleration or deceleration of a shaft that passes through. To enable the elastic effect, the pass-through openings through the body of the gearwheel are dimensioned somewhat larger than the connecting elements leading through them, which, like the flanges, are made of a rigid metallic material.

It is in particular the gear rim and the elastic elements as well that constitute the components of such a gearwheel arrangement and, that as the weakest components, determine the service life of such a gearwheel.

In general, such a gearwheel arrangement has many disadvantages. The production of the many components is complex and therefore expensive in view of the large number of components and also in view of their complicated configuration.

The gear rim or body of the actual gearwheel has numerous passages or pass-through openings for torque entrainment. In a gearwheel made of injection-molded plastic, there therefore exists a corresponding number of joint lines in the form of seams on the outside or inside diameter caused by injection molding. Another weakness of the gearwheel or of the mass forming the inside the gearwheel is attributable to the passages themselves, since these passages ultimately represent missing material underneath the toothing and each of them is necessarily associated with the formation of a joint line.

A wheel rim configured in this manner has radially varying stiffnesses. The stiffness is low in the vicinity of the passages, leading to higher deformation of the plastic, whereas high stiffness exists in the vicinity of webs between the individual passages. A high radial and peripheral force acts on the gear rim when the torque load is high, providing for a high walk-effect and additional bending in the vicinity of the passages. The large differences in wall-thickness which exist in such a gearwheel and which partially require large wall thicknesses in order to ensure adequate strength, are a disadvantage. But this causes high cycle times in injection molding manufacture due to the very large wall thicknesses required.

Torque entrainment is theoretically distributed to all cams through connecting elements. However, due to deformation under load, the torque is primarily transmitted only by individual connecting elements, especially by only two connecting elements of this type. This leads to high local stresses.

It is the object of the invention to suggest a motor vehicle gearwheel arrangement and power steering system drive gearwheel arrangement having a configuration that enables a more uniform and, in regard to stability, more favorably distributed arrangement of regions that participate in transmitting the torque of the actual gearwheel. This should in particular increase the strength of the gearwheel and thereby increase service life. This will preferably also improve the elastic properties upon changes in positive or negative accelerations.

This object is achieved by means of a motor-vehicle gearwheel arrangement having the features according to claim 1 or 2 or respectively by using such a gearwheel arrangement as an element of a power steering system drive.

The structural configurations achieve higher loading capacity, better damping when tooth engagement is afflicted with play, a better method of connecting between the flange and the disk or the flange and the gearwheel and, finally, a cost reduction in the manufacture of such a gearwheel arrangement due to the manufacturability of a gearwheel body with smaller axial extension and due to the reduction in the number of components having a complicated structure.

The invention thus proceeds from a motor-vehicle/gearwheel arrangement for a motor-vehicle auxiliary gearing having a gearwheel, having a flange arrangement with at least one, preferably two flanges, with the gearwheel being arranged adjacent to at least one of the flanges so that they rotate about a common rotational axis and engage one into the other and with at least one connecting element for connecting the gearwheel to at least one of the flanges. An arrangement according to a first independent embodiment is advantageous in that the gearwheel has at least one connecting-element receiving depression which leads into the body of the gearwheel parallel to the rotational axis, or has an elevation for receiving the connecting element rising from the body of the gearwheel.

The arrangement according to a second independent embodiment is advantageous in that the at least one flange has at least one connecting-element receiving depression which leads into the body of the flange parallel to the rotational axis, or has an elevation for receiving the connecting element rising from the body. The two embodiments therefore differ by a mirror-inverted arrangement of the individual interconnecting components.

Such configurations enable a configuration of the body of the gearwheel such that the entire surface, as seen from a top view in the axial direction, is without passages or pass-through openings passing through the body. Joint lines are thereby avoided. Preferably, approximately uniform thicknesses of the wall material of the body in the axial direction are also made possible. In the ideal case, this ensures the highest possible carrying capacity for the gear rim of the gearwheel. The entrainment of the gearwheel by the flange elements or, conversely, the entrainment of the flange elements by the gearwheel occurs by means of the connecting element dipping into the connecting-element receiving depression and, possibly, via the elevations, which dip into corresponding elevation receiving depressions on the opposite body.

The connecting-element receiving depression therefore preferably leads into the body of the gearwheel without breaking through it.

The at least one connecting element is particularly made of an elastic material, preferably a thermoplastic elastomer. This type of elastic configuration of the connecting element in regard to the elasticity relative to the choice of material of the gear rim and the flanges, which are made to be relatively rigid, enables the damped transmission of forces from the gearwheel to the flange and vice versa when a positive or negative acceleration acts on the gearwheel arrangement in a particularly abrupt manner.

The connecting-element receiving depression and/or the elevation on one side and the connecting element on the other side can be configured to receive the connecting element in a rotationally fixed manner, especially with a positive fit. To this end, the elevation is preferably designed to be rib-shaped or web-shaped, and the connecting element preferably has a recess, with the recess being designed for connecting the connecting element and the elevation with a positive fit. This type of positive-fit connection of the connecting element to the two components connected by the connecting element enables a direct transmission of a change in acceleration acting on the flange or on the gear rim of the gearwheel.

When an elastic connecting element is used in particular, the transmission of even a jerky or abruptly occurring acceleration torque will not only be delay-free, but preferably also damped.

If the recess in the connecting element is designed to be dimensionally smaller than the elevation, and if the connecting element is made of an elastic material, this will not only allow the connecting element to be placed on the elevation with a positive fit, but it will also allow it to sit tightly on the elevation so that the connecting element will not fall down from the elevation during assembly or be displaced in the longitudinal extension of a preferably rib-shaped elevation.

The connecting-element receiving depression is preferably designed to be dimensionally smaller than the connecting element, and the connecting element is then preferably made of an elastic material. In such a configuration, the connecting element can be inserted into the connecting-element receiving depression for assembly without falling out of it during the assembly process. Such a configuration also makes sure that the connecting element sits in the connecting-element receiving depression free from play, thereby enabling an immediate damped but delay-free transmission of torque changes when such changes in torque occur.

The connecting-element receiving depression and the connecting element can be designed to be circular, thus simplifying assembly. But the connecting-element receiving depression and the connecting element can also be noncircular, especially with corner areas. In particular, the connecting elements that are configured as damping elements are deformed or compressed to such an extent that a direct entrainment between the gear rim or gearwheel on the one hand and flange or disk on the other hand occurs. According to the various embodiments, the gear rim is centered in the flange or the flange and the disk by cylindrical or noncircular, especially prism-like elements in the form of the connecting elements. This prevents a radial descent or a reduction of the depth of engagement of a worm gear or another structure engaging the gearwheel so that the toothing will have a higher carrying capacity.

The at least one elevation on the gearwheel preferably engages at least one elevation receiving depression on the flange radially and axially with a positive fit and/or the at least one elevation on the flange preferably engages an elevation receiving depression in the body of the gearwheel parallel to the rotational axis.

The at least one elevation on the gearwheel preferably engages at least one elevation receiving depression on the flange that is radially dimensioned to be larger than the elevation and/or the at least one elevation on the flange preferably engages at least one elevation receiving depression which is designed to be larger in the radial or peripheral direction than the elevation in the body of the gearwheel. It is particularly in connection with an elastic connecting element, which provides for a connection between the gearwheel and the at least one flange with a full positive fit, that such a smaller dimensioning, particularly of rib-shaped or web-shaped elevations which dip into more largely dimensioned elevation receiving depressions on the opposite part, makes it possible for the plastic connecting parts to first provide a damped rather than a jerky transmission of the acceleration when there is a change in acceleration, before a particularly positive fitting connection between the elevation and elevation receiving depression provides for a fully undamped further transmission of the torque.

The elevations can in particular be configured as web-shaped elements or ribs. A rib structure that is configured in this manner and is preferably interleaved enables constant wall-thickness ratios on the gear rim and/or on the flange. This permits a shorter cycle time in injection molding, because it enables overall thinner wall thicknesses of the individual components. A high stiffness is nevertheless maintained. In particular, this also enables an extensive transmission of the torque between the gear rim and the flange or the gear rim and disk, which is designed to be an alternative to a flange on one side of the gear rim or gearwheel. However, interior contours on both sides of the gearwheel that are directed toward the latter are preferably configured to be identical for the flanges lying opposite each other in the flange configuration. This enables a reduction in the number of components that are configured to be different from each other.

A hub, which is configured to be a metal hub and is to be encased in plastic, with the plastic having a textured structure, which engages an inversely textured structure of a flange opening of the at least one flange, is preferred. A configuration of this type enables a hub configuration which advantageously enables a positive fitting connection to at least one such flange so that torques can be transmitted directly between the flange and the hub.

The at least one flange preferably has a cylindrical flange projection, which has a flange opening for receiving a hub and which is configured to extend, proceeding from the flange, in a direction parallel to the rotational axis, at least partially through a gearwheel/shaft opening of the gearwheel, without engaging. The flange projection preferably has entraining elements, which project in a direction parallel to the axis and immerse into immersing entraining elements of an opposite flange, the entraining elements of the opposite flange being dimensioned larger relative to the projecting entraining elements. The entraining elements configured in this manner provide for a more gentle and damped transmission of the torque when the torque changes, especially in combination with the elastic connecting elements. An adjoinment with a full positive fit in the rotational direction will occur only after a time delay, and this adjoinment will, after a delay, then provide for the transmission of the torque through the entraining elements that immerse into one another. Such additional entraining elements can, for example, be pins or cylinder pieces molded onto the flange. For small torques, these are adequately distanced from the gear rim so that the damping elements in the form of the elastic connecting elements keep the gear rim decoupled. This offers particular acoustic advantages, because it allows less noise to develop.

The gearwheel and the at least one flange are preferably made of injection-molded plastic and can therefore be produced in a simple and inexpensive manner.

Such a gearwheel arrangement offers many further advantages. The metal hub, which is encased with plastic, thereby enabling a fitted insertion into the flange with a positive fit in a simple manner, can be pointed out as an example. A disk, which is made of plastic and is configured as the body of the gearwheel and which dips radially and axially into an opposite flange contour with a positive fit is also particularly advantageous. To this end, appropriately dimensioned clearances are preferably retained for the contours that reach into one another so that the elastic connecting elements enable a damping effect.

For small torques, a light radial restraint holds the gear rim or gearwheel to the mating gear without play, this being enabled by a small axial clearance. To this end, a damping in the zero position and a very soft design, especially in the radial direction, are advantageous. For higher torques, the gear rim would normally be very strongly displaced radially, but the present design can largely or completely prevent this. The configuration of the connecting elements as damping elements supports this effect in an advantageous manner. The additional ribbed structure on the lateral body of the gearwheel advantageously provides wrap-around support to the gear rim, thereby achieving a reduced walk effect.

The connecting elements, which can be assembled without great expense, can be used as damping elements in a simple manner. This prevents weak points that are at risk for crack formation inside the damping structures since there are no transitions from surrounding structures to structures standing apart from them. A wide variety of materials can be used as damping materials for the connecting elements. In particular, damping materials made of thermoplastic elastomers or similar materials can in principle be injected into the flange elements or the gear rim as a second component. In particular, this permits a more decentralized arrangement of the damping elements even relatively far outwards as viewed from the rotational axis. Trouble-causing material connections of damper element to damper element, which interrupt the rib structure, are avoided.

Particularly preferred, in place of one flange and a disk located opposite said flange on the other side of the gearwheel, are two identical flanges, which are preferably configured so that one and the same flange element can be used for both sides, that is, used to provide both flanges. Instead of molding flange elements into the hub, it is optionally possible to mount the flanges directly on the hub. This permits lower manufacturing costs, since the effort during manufacture is reduced.

An example embodiment will be explained in detail below on the basis of the drawing. To this end, modified embodiments will also be presented in addition to a basic embodiment. Components with the same construction or same function are labeled with the same reference characters throughout the various embodiments. Components that are structurally modified relative to the corresponding components of another embodiment but have the same functionality in regard to the basic concept are represented with additional characters, especially “*” or “°”. In particular, in regard to modified embodiments, only the respective modifications will be described, making use of references to the explanations of the remaining embodiments. The drawing shows:

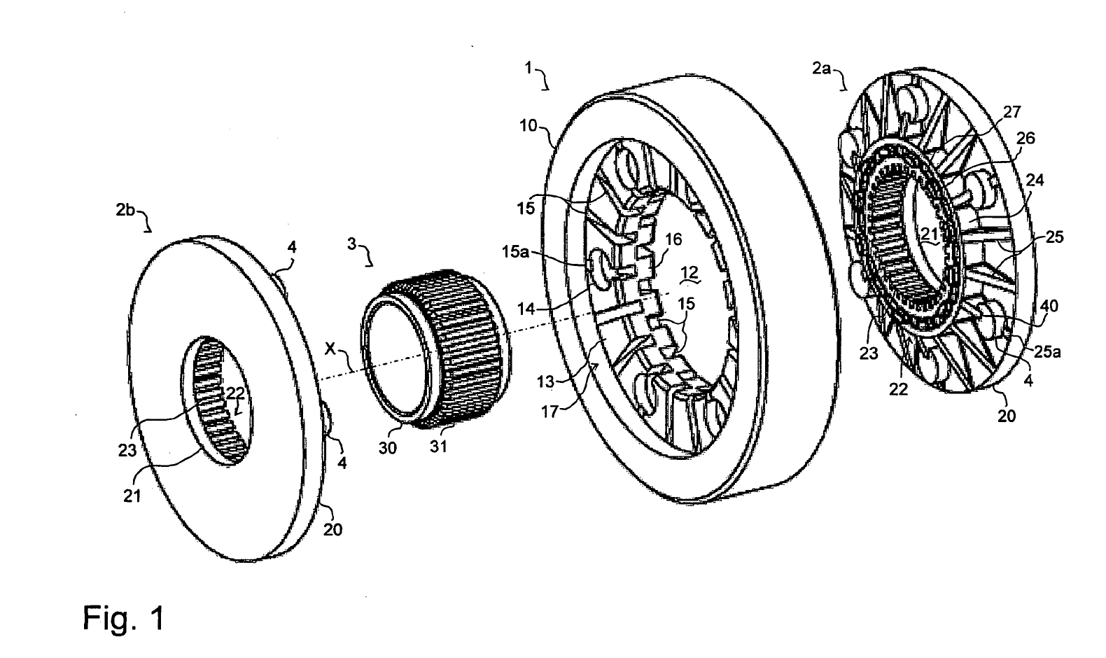

FIG. 1 a gearwheel arrangement according to a preferred embodiment with disassembled components in perspective view,

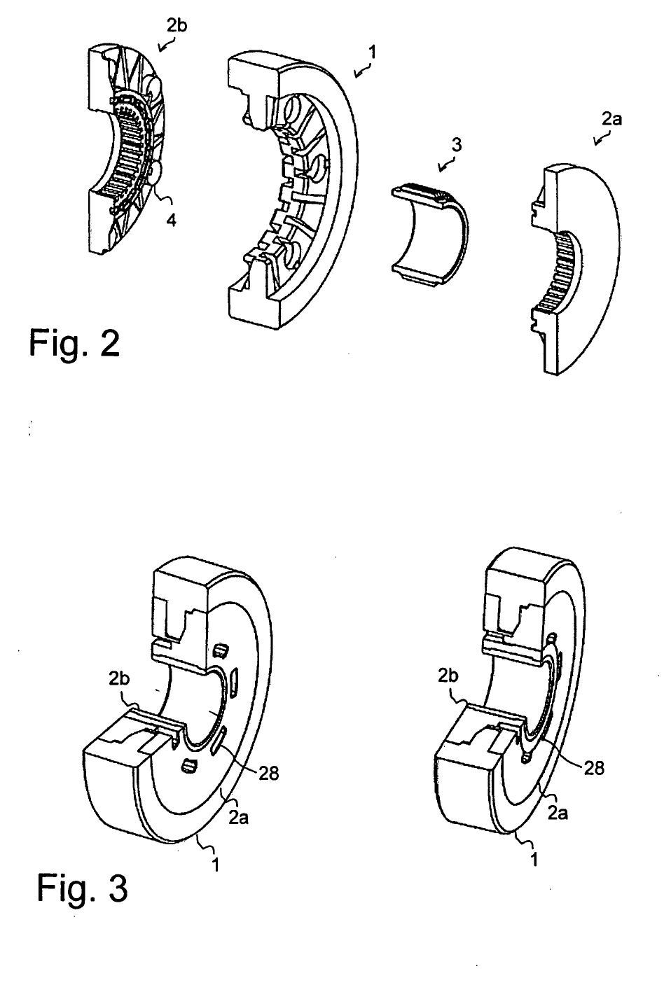

FIG. 2 a perspective partial-section view through such a gearwheel arrangement,

FIG. 3 an embodiment modified in comparison therewith,

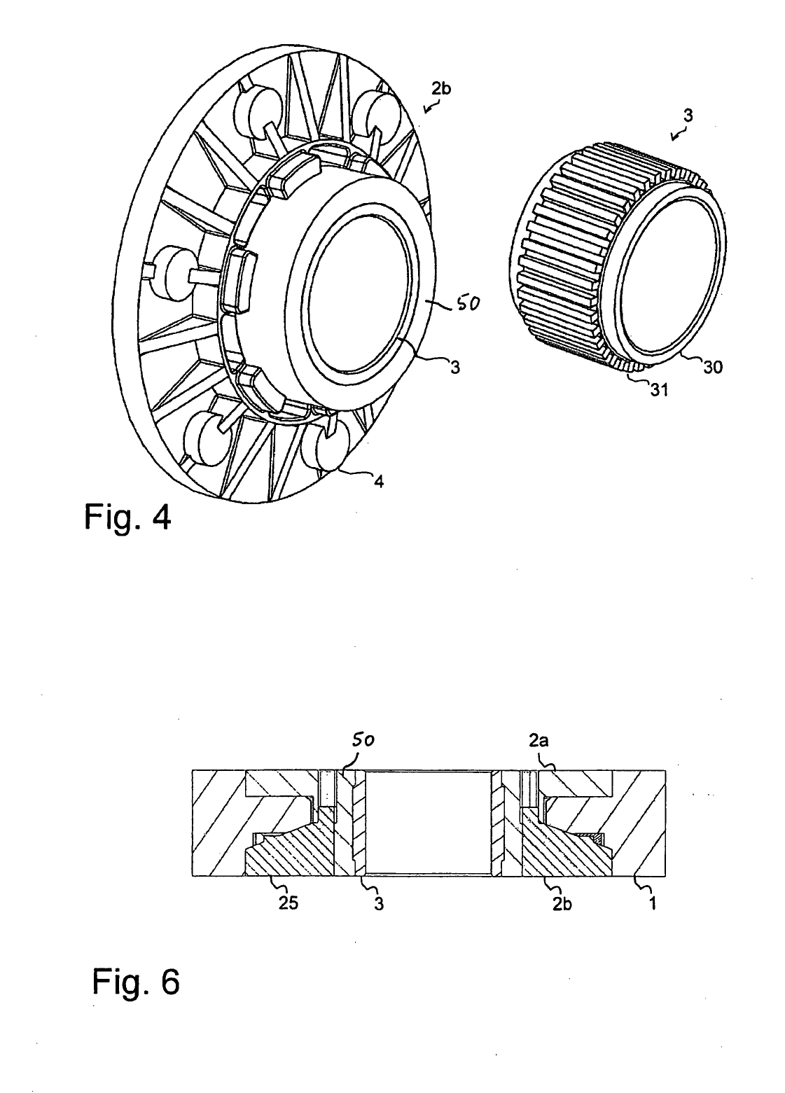

FIG. 4 a preferred flange element and a hub element in perspective view,

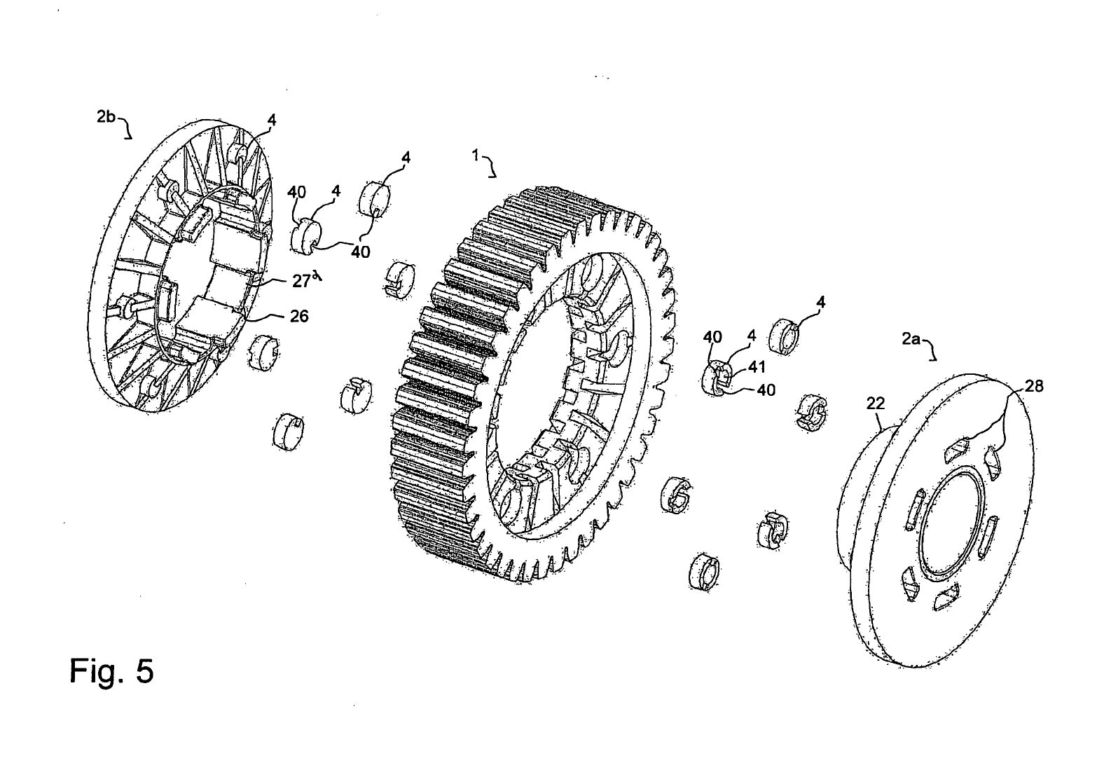

FIG. 5 another view of an embodiment modified relative to FIG. 1 in disassembled perspective view to illustrate the construction of connecting elements,

FIG. 6 a sectional view through an assembled gearwheel arrangement with components according to FIG. 5,

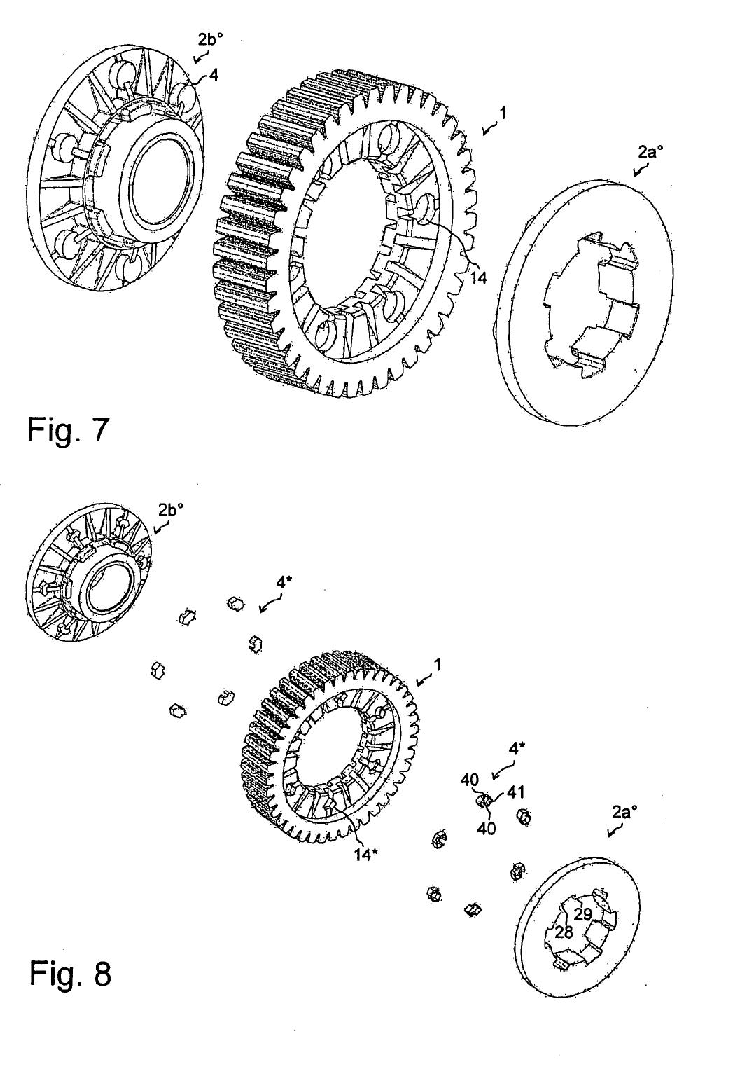

FIG. 7 another view of the components according to the embodiment of FIG. 5, and

FIG. 8 an embodiment modified with respect to the configuration of the connecting elements in a separated perspective view.

The figures, especially FIG. 1, show an example of a gearwheel arrangement, which can advantageously be used as a motor-vehicle gearwheel arrangement in a power steering system drive. A gear rim 10 of a gearwheel 1 engages a worm gear, whereby a rotation of the gear rim 10 is transmitted to or by a shaft. To the side of the gearwheel 1 there are two flanges 2a, 2b or one flange 2a and an opposing disk, which are arranged so as to rotate around a common rotational axis X, which is simultaneously the rotational axis of the gearwheel 1. The configuration is such that torque is transmitted through the flange or flanges 2a, 2b from the gearwheel 1 to a shaft or a hub 3, which is connected in a rotationally fixed manner to the flanges 2a, 2b in a central flange opening 21.

In particular, the hub 3 can be configured as a metal tube 30 with an external tubular toothing 31, which engages a flange-opening toothing 23 in the region of the flange opening 21. The tubular toothing 31 can be configured particularly simply by molding plastic onto the metal tube 30.

The flanges 2a, 2b are preferably each configured with a flange projection 22. The flange projection 22 is configured so that it runs parallel to rotational axis X and extends into a gearwheel/shaft opening 12. To this end, it is preferred but not necessary that a continuous outside wall 24 of the flange projection 22 is inserted into the gearwheel/shaft opening 12 in such a manner that no rotationally-fixed connection with an inside wall 16 of the gearwheel/shaft opening 12 of the gearwheel 1 occurs.

A side wall of the flange 2a facing the gearwheel 1 is configured with elevations 25, which preferably extend in a rib-like manner, with increasing width, from the outer circumference of the respective flange 2a, 2b to the most distant edge of the corresponding flange projections 22. A correspondingly opposing side wall 13 of the body 10 of the gearwheel 1 has corresponding elevation receiving depressions 15 which, in the case of rib-shaped elevations 25, are configured in the shape of corresponding grooves.

The elevation receiving depressions 15 are dimensioned so that they can be taken up in these engaging elevations 25 in the axial direction with a positive fit. In the radial direction, which is in particular also understood to mean a circumferential direction around the rotational axis X, the elevation receiving depressions 15 preferably offer some play, so that the elevations 25 can rotate slightly before a positive fit and the transmission of torque occur.

The wall 13 of the gearwheel 1 opposite the flange 2a, 2b is preferably shifted back or recessed in the axial direction in relation to an outer circumference by an amount equal to a width of the body of the corresponding flange 2a, 2b. This forms a gearwheel arrangement which forms a flush front face of the gearwheel body 10 and flange 2a, 2b in the axial direction.

To enable a damped transmission of torques when there is a change of positive or negative acceleration, the flange or flanges 2a, 2b and the gearwheel 1 are connected to each other by elastic connecting elements 4. In the illustrated embodiments, the surface 13 of the gearwheel 1 opposite the respective flange 2a, 2b has connecting-element receiving depressions 14, which serve to receive the connecting elements 4. The dimensioning is then preferably chosen in such a manner that the connecting-element receiving depressions 14 are designed to be contoured and dimensioned identical to or smaller than the connecting elements, so that the connecting elements are received therein with slight initial tension or with a positive fit. The connection of the connecting elements 4 to the opposing flange 2a, 2b is accomplished by superposition on a portion of the elevations 25a. For this purpose, the connecting elements have corresponding recesses 40, which are preferably shaped to fit the corresponding elevations 25a tightly. In the case of the rib-shaped elevations 25a with increasing height, the recesses 40 are appropriately guided at an angle through the body of the elastic connecting elements 4. The elevations 25a are preferably made to be somewhat wider than the corresponding recess 40 so that the connecting elements 4 can be attached to the corresponding elevation 25a for assembly without falling down again during assembly or being inadvertently displaced along the elevation 25a.

According to alternative designs, connecting-element receiving depressions can correspondingly also be shaped into the body of the flange in addition to or instead of corresponding connecting-element receiving depressions 14 in the body of the gearwheel 1. Accordingly, additional or alternative elevations, especially rib-shaped elevations, which accordingly engage correspondingly shaped elevation receiving depressions on the opposite flange, can be provided on the side wall 13 of the gearwheel 1, such designs not being illustrated.

As additional optional advantageous elements, entraining elements configured in the axial direction, parallel to the rotational axis X are provided on the flange projections 22. The projecting entraining elements 26 are then shaped so that they engage entraining elements 28 configured as depressions or openings that penetrate into the opposing flange 2a, 2b.

FIG. 2 and FIG. 3 illustrate different configurations of the flanges 2a, 2a°. Thus the flanges 2a° in FIG. 3 have recesses parallel to the axis, which is only an optional feature.

FIG. 4 depicts a perspective view of a flange 25 having a hub 3 that is inserted therein and is already encased with plastic 50, where a preferred hub 3 having rib-shaped toothing parallel to the axis as tubular toothing 31 is depicted in the right-hand part of the drawing. The tubular toothing 31 preferably serves as retaining ribs for the plastic 50 that is to be injected therupon.

Various configurations of the particularly preferred connecting elements 4, 4* are illustrated on the basis of FIG. 5 vs. FIG. 8. Whereas the connecting elements 4 in FIG. 5 have a circular outer circumference and the connecting-element receiving depressions 14 are accordingly configured to be correspondingly circular, the alternatively designed connecting elements 4* in FIG. 8 are made to be noncircular. The connecting-element receiving depressions 14* in the side wall of the gearwheel 1 are correspondingly shaped to be noncircular.

The connecting elements are preferably made of elastic solid bodies. But the connecting elements 4, 4* can also be made of hollow bodies, as shown in FIGS. 5 and 8.

1. Motor-vehicle/gearwheel arrangement for a motor-vehicle auxiliary gearing having
a gearwheel (1, 1*),
a flange arrangement with at least one, preferably two flanges (2a, 2b; 2a°, 2b°), with the gearwheel (1, 1*) being arranged adjacent to at least one of the flanges (2a, 2b; 2a°, 2b°) such that they rotate about a common rotational axis (X) and engage one into the other, and
at least one connecting element (4, 4*) for connecting the gearwheel (1, 1*) to at least one of the flanges (2a, 2b; 2a°, 2b°), characterized in that
the gearwheel (1, 1*) has at least one connecting-element receiving depression (14, 14*) which leads into the body of the gearwheel (1, 1*) parallel to the rotational axis (X), or has an elevation for receiving the connecting element (4, 4*) extending from the body of the gearwheel.

2. Motor-vehicle/gearwheel arrangement for a motor-vehicle auxiliary gearing having
a gearwheel (1, 1*),
a flange arrangement with at least one, preferably two flanges (2a, 2b; 2a°, 2b°), with the gearwheel (1, 1*) being arranged adjacent to at least one of the flanges (2a, 2b; 2a°, 2b°) such that they rotate about a common rotational axis (X) and engage one into the other, and
at least one connecting element (4, 4*) for connecting the gearwheel (1, 1*) to at least one of the flanges (2a, 2b; 2a°, 2b°), characterized in that
the at least one flange (2a, 2b; 2a°, 2b°) has at least one connecting-element receiving depression which leads into the body of the flange parallel to the rotational axis (X), or has an elevation (25a) for receiving the connecting element (4, 4*) rising from the flange body.

3. Gearwheel arrangement according to claim 1 in which the connecting-element receiving depression (14, 14*) leads into the body of the gearwheel (1) without breaking through it.

4. Gearwheel arrangement according to claim 1 in which the at least one connecting element (4, 4*) is made of an elastic material, particularly a thermoplastic elastomer.

5. Gearwheel arrangement according to claim 1 in which the connecting-element receiving depression (14, 14*) and/or the elevation on one side and the connecting element (4, 4*) on the other side are configured to receive the connecting element in a rotationally fixed manner, especially with a positive fit.

6. Gearwheel arrangement according to claim 5 in which the elevation (25a) is made to be rib-shaped or web-shaped, and the connecting element (4, 4*) has a recess (40), with the recess (40) being configured so that it connects the connecting element (4, 4*) and the elevation (25a) with positive fit.

7. Gearwheel arrangement according to claim 6 in which the recess (40) is configured to be dimensioned smaller than the elevation (25a) and in which the connecting element (4, 4*) is made of an elastic material.

8. Gearwheel arrangement according to claim 1 which the connecting-element receiving depression (14, 14*) is configured to be dimensioned smaller than the connecting element (4, 4*), and the connecting element (4, 4*) is made of an elastic material.

9. Gearwheel arrangement according to claim 1 in which the connecting-element receiving depression (14) and the connecting element (4) are configured to be circular.

10. Gearwheel arrangement according to claim 1 in which the connecting-element receiving depression (14) and the connecting element (4) are configured to be noncircular, especially with corner areas.

11. Gearwheel arrangement according to claim 1 in which the at least one elevation on the gearwheel (1) engages at least one elevation receiving depression on the flange (2a, 2b) radially and axially with a positive fit and/or the at least one elevation (25, 25a) on the flange (2a) engages an elevation receiving depression (15, 15a) in the body of the gearwheel (1) parallel to the rotational axis (X).

12. Gearwheel arrangement according to claim 1 in which the at least one elevation on the gearwheel engages at least one elevation receiving depression on the flange dimensioned radially larger than the elevation and/or the at least one elevation (25, 25a) on the flange (2a) engages at least one elevation receiving depression (15, 15a), which is configured to be larger in the radial or peripheral direction than the elevation (25, 25a) in the body of the gearwheel.

13. Gearwheel arrangement according to claim 1 in which the elevations (25, 25a) are configured as web-shaped elements or ribs.

14. Gearwheel arrangement according to claim 1 having a hub (4), which is configured as a metal hub and is encased in plastic, with the plastic having a textured structure, which engages an oppositely textured structure of a flange opening (21) of the at least one flange (2, 2a).

15. Gearwheel arrangement according to claim 1 in which the at least one flange (2a, 2b) has a cylindrical flange projection (22), which has a flange opening (21) for receiving a hub (4) and which is configured to extend, proceeding from the flange (2, 2a) in a direction parallel to the rotational axis (X), at least partially through a gearwheel/shaft opening (12) of the gearwheel (1) without engaging.

16. Gearwheel arrangement according to claim 15 in which the flange projection (22) has entraining elements (26), which project in a direction parallel to the axis and reach into projecting entraining elements (27) of an opposite flange (2b), with the entraining elements of the opposite flange being dimensioned larger relative to the projecting entraining elements.

17. Gearwheel arrangement according to claim 1 in which the gearwheel (1) and the at least one flange (2a, 2b) are made of plastic by injection molding.

18. Power steering system drive gearwheel arrangement having a gearwheel arrangement according to claim 1.
